(19) United States
(12) Patent Application Publication
(10) Pub. No.: US 2003/0155865 A1
(43) Pub. Date: Aug. 21, 2003

(54) Filter

(76) Inventors: Masaharu Ito, Tokyo (JP); Kenichi Maruhashi, Tokyo (JP); Keiichi Ohata, Tokyo (JP)

Correspondence Address: SUGHRUE MION, PLLC, 2100 PENNSYLVANIA AVENUE, N.W., WASHINGTON, DC, 20037, US

(21) Appl. No.: 10/332,267

(22) PCT Filed: Jul. 6, 2001
(86) PCT No.: PCT/JP01/05894

(30) Foreign Application Priority Data
Jul. 7, 2000 (JP) 2000-207459

(51) Int. Cl. H05B 39/04

(52) U.S. Cl. 315/100

(57) ABSTRACT

A dielectric waveguide tube band-pass filter assuming lower characteristic change upon mounting, and having smaller dimensions and lower loss. Conductor layers (2a, 2c) are formed on the top and bottom surfaces of a dielectric substrate (1), wherein the top conductor layer 2a and the bottom conductor layer 2c are connected together through via-holes (3a). The via-holes (3a) are formed in at least two rows along the signal transfer direction. In the dielectric waveguide tube configured by the top and bottom conductor layers (2a, 2c) and the via-holes (3a), via-holes (3b) are arranged in the signal transfer direction at spacing equal to or below ½ of the in-tube wavelength to thereby configure resonators. The dielectric band-pass filter is configured by coupling adjacent resonators together through the via-holes (3b) configuring inductive windows. On the surface of the dielectric substrate (1), a co-planar line (4) including the conductor layer (2) as the ground and the conductor layer (2b) as a signal conductor is configured so as to overstride the inductive windows configured by the via-holes (3a).

### TECHNICAL FIELD

The present invention relates to a filter having a dielectric waveguide tube structure for use as a high-frequency component.

### TECHNICAL BACKGROUND

Conventional filters used in a high-frequency range include a filter using a ¼-wavelength or ½-wavelength resonator including micro-strip or coplanar line, which is a planar filter expected to have smaller dimensions.

Waveguide tube filters which can be expected to have a lower loss include a dielectric waveguide tube filter, which is smaller in dimensions compared to a rectangular waveguide tube. In the dielectric waveguide tube filter described in Patent Publication JP-A-11-284409, for example, and shown in FIG. 11, the waveguide tube is configured by forming conductor layers 2a and 2c on the top and bottom surfaces of a dielectric substrate, the top conductor layer 2a and the bottom conductor layer 2c are connected together through via-hole arrays 3a, which are formed so that a spacing lp along the signal transfer direction is equal to or less than ½ of the in-tube wavelength. In addition, via-holes 3b constituting the inductive windows are formed in the waveguide tube thus configured so that the spacinges (l1, l2, l3 and l4) are equal to or less than ½ of the in-tube wavelength, thereby realizing a filter.

However, in the planar filter, since the electromagnetic wave is concentrated in a narrow area, the loss thereof increases due to the conductor loss or dielectric loss. In addition, since the electromagnetic wave expands outside the dielectric substrate constituting the planar filter, there is a problem in that the filter characteristic is changed due to the influence by a package when it is mounted on the package.

Further, as for the dielectric waveguide tube filter described in JP-A-11-284409, if a filter having a steep out-of-band suppression characteristic is to be achieved therefrom, the filter will have a larger number of stages and thus larger dimensions. Thus, there also arises a problem in that designed characteristics cannot be achieved due to limited manufacturing accuracy.

### SUMMARY OF THE INVENTION

In view of the above, it is an object of the present invention to provide a filter assuming smaller characteristic change upon mounting thereof, and having smaller dimensions and lower loss. The present invention provides a dielectric waveguide tube filter having a dielectric waveguide tube structure comprising a top conductor layer and a bottom conductor layer on the surfaces of a dielectric substrate, wherein the side wall of a waveguide tube and inductive windows are configured by conductors connecting the top conductor layer and the bottom conductor layer together, characterized in that: a planar line is configured on the surface of at least one of the top conductor layer and the bottom conductor layer.

In the filter of the present invention, it is preferable that at least two via-hole arrays be formed wherein via-holes connecting together the top conductor layer and the bottom conductor layer disposed on the surfaces of the dielectric substrate are arranged in rows along the signal transfer direction at a spacing equal to or below ½ of the in-tube wavelength in the desired band, and the inductive windows coupling together the resonators formed by the area surrounded by the via-hole arrays, top conductor layer and the bottom conductor layer be configured by the via-holes.

In addition, it is preferable that the planar line formed on the top conductor layer or the bottom conductor layer overstride at least one of the windows, thereby configuring a transmission path.

It is also preferable that a planar line formed on the dielectric substrate constitute a coplanar line including two combined slots formed along the transfer direction of the signal transferring within the waveguide tube.

It is preferable that the ground conductors on both sides of the signal conductor constituting the coplanar line be connected together via a conductor piece.

It is preferable that the conductors disposed on both sides of the slots constituting the planar line be connected together via a conductor piece for adjusting the filter.

It is preferable that at least one of both sides of the coplanar line be an open end, a first conductor piece be formed apart from the open end of the signal conductor, and the first conductor piece and the signal conductor be connected together via a second conductor piece for adjusting the filter.

It is preferable that the filter include a coplanar line for inputting/outputting a signal, and a coplanar waveguide tube conversion structure.

It is preferable that the conductors constituting the coplanar line be connected together via a conductor piece formed on a flip-chip mounting substrate and bumps.

### BRIEF DESCRIPTION OF THE DRAWINGS

FIG. 1A is a top plan view of a filter according to a first embodiment of the present invention, and FIG. 1B is a sectional view taken along line A-A′ in FIG. 1A.

FIG. 2 is a top plan view of a filter according to a second embodiment of the present invention.

FIG. 3 is a top plan view of a filter according to a third embodiment of the present invention.

FIG. 4 is a top plan view of a filter according to a fourth embodiment of the present invention.

FIG. 5A is a top plan view of a filter according to a fifth embodiment of the present invention, and FIG. 5B is a sectional view taken along line B-B′ in FIG. 5A.

FIG. 6A is a top plan view of a filter according to a sixth embodiment of the present invention, and FIG. 6B is a sectional view taken along line C-C′ in FIG. 6A.

FIG. 7A is a top plan view of a filter according to a seventh embodiment of the present invention, and FIG. 7B is a sectional view taken along line D-D′ in FIG. 7A.

FIG. 8A is a top plan view of a filter according to an eighth embodiment of the present invention, and FIG. 8B is a sectional view taken along line E-E′ in FIG. 8A.

FIG. 9 is a sectional view of a filter according to a ninth embodiment of the present invention.

FIG. 10 is a sectional view of a filter according to a tenth embodiment of the present invention.

FIG. 11A is a top plan view of a conventional filter, and FIG. 11B is a sectional view taken along line F-F′ in FIG. 11B.

FIG. 12 is a graph showing the effect of improvement in the out-of-band suppressing characteristic obtained by the coplanar line.

FIG. 13 is a graph showing filter characteristic having two attenuation poles in the low frequency range.

FIG. 14 is a graph showing filter characteristic having an attenuation pole in each of the low frequency range and the high frequency range.

### BEST MODES FOR THE INVENTION

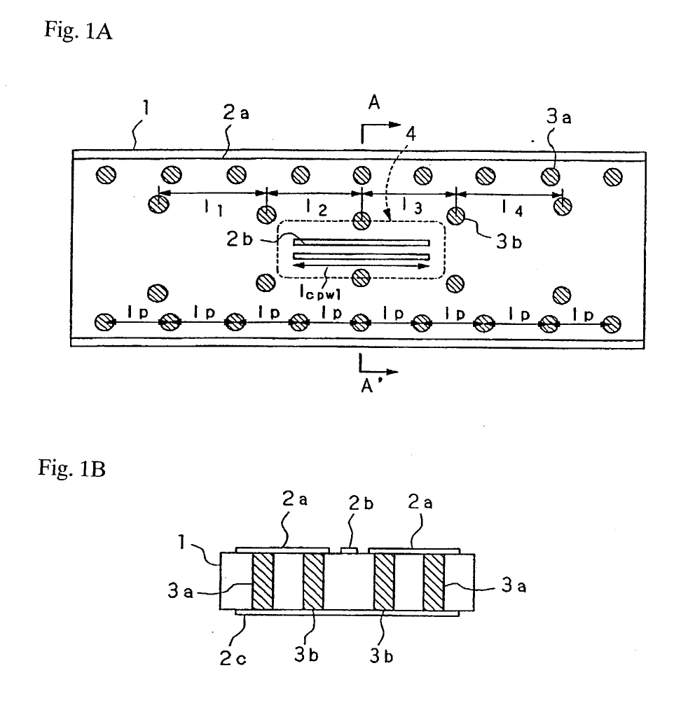

With reference to FIGS. 1A and 1B, a first embodiment of the present invention will be described in detail. Conductor layers are formed on the top surface and the bottom surface of a dielectric substrate such as made of ceramics, wherein the top conductor layer 2a and the bottom conductor layer 2c are connected together through via-holes 3a penetrating the dielectric substrate 1. The plurality of via-holes 3a are formed at least in two rows along the signal transfer direction. In order for the area surrounded by the top conductor layer 2a, bottom conductor layer 2c and via-holes 3a to configure a waveguide tube in a desired band, it is preferable that the spacing lp of the via-holes 3a along the signal transfer direction be equal to or below ½ of the in-tube wavelength in the desired band. In addition, in order to sufficiently suppress the loss due to the radiation from between the via-holes 3a, it is preferable that the spacing be equal to or below ¼ of the in-tube wavelength. By forming via-holes 3b arranged in the dielectric waveguide tube at spacings (l1, l2, l3 and l4) which are below ½ of the in-tube wavelength along the signal transfer direction, the zone sandwiched between the via-holes 3b configures a resonator. In addition, by coupling the adjacent resonators through the via-holes 3b constituting inductive windows, a dielectric band-pass filter is configured.

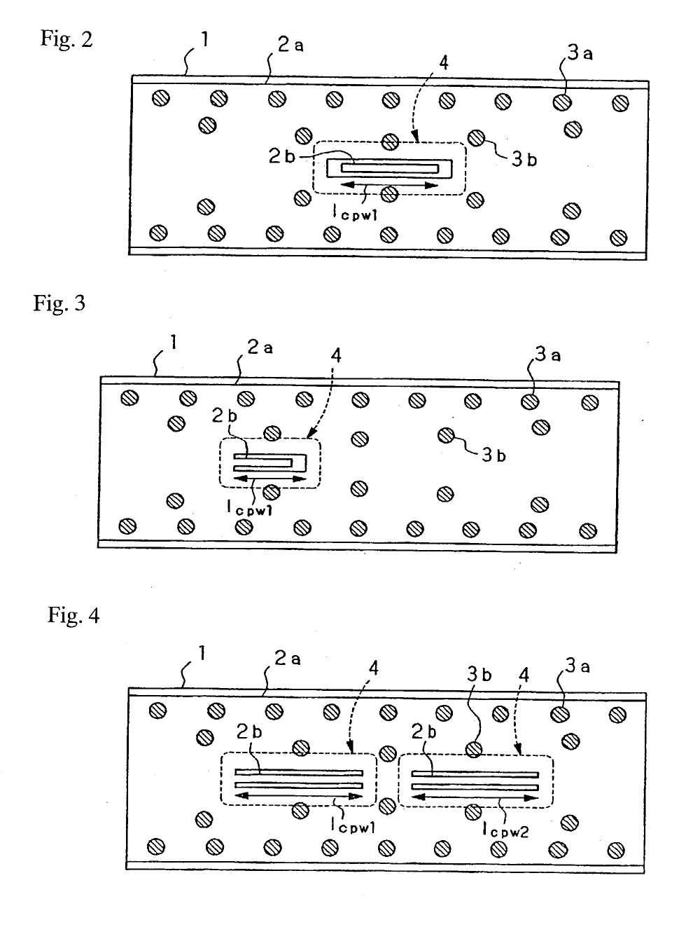

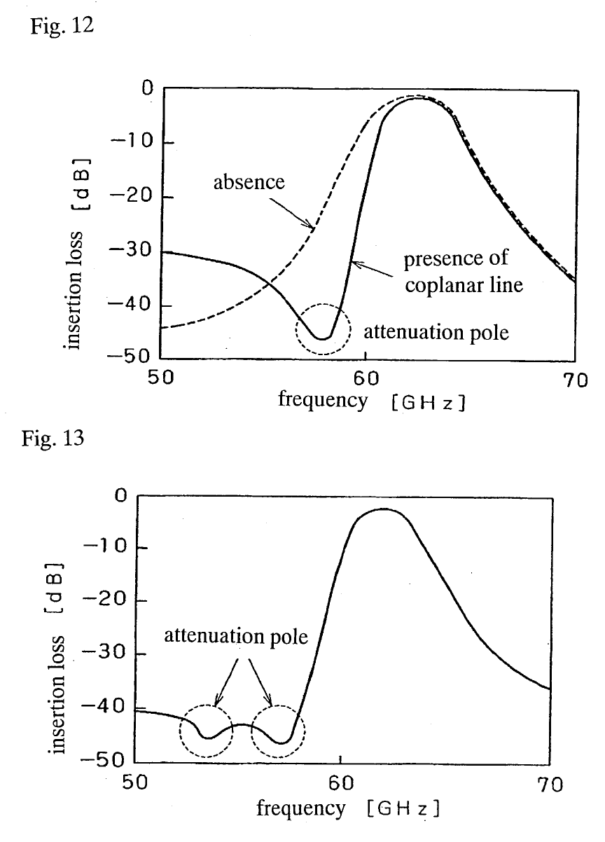

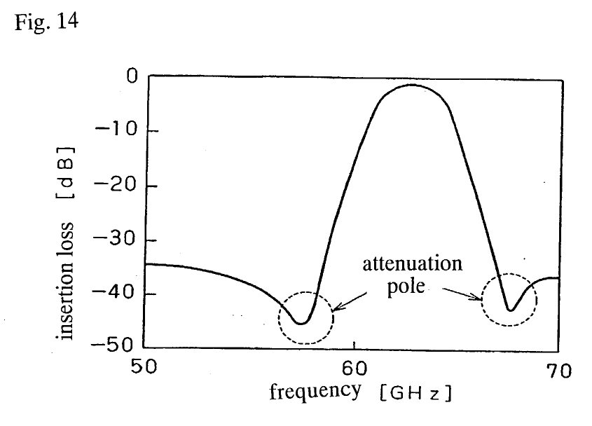

Further, coplanar line 4 having the conductor layer 2a as a ground and the conductor layer 2b as a signal conductor is formed so as to overstride the inductive windows configured by the via-holes 3b. This structure provides a subordinate transmission path having short-circuited ends and having a length, lcpw1, which is around ½ of the in-tube wavelength. FIG. 12 shows the filter characteristic in the cases of presence and absence of the subordinate transmission path. As seen from FIG. 12, addition of the subordinate transmission path introduces an attenuation pole outside the pass band, whereby the out-of-band suppressing characteristic can be significantly improved. As a result, the number of stages of the filter for achieving a desired suppressing characteristic can be reduced compared to the case of absence of the subordinate transmission path, thereby reducing the dimensions of the filter. The attenuation pole may be introduced by a transmission path having open ends and a length, lcpw1, around ½ of the in-tube wavelength such as provided in a second embodiment of the present invention, as shown in FIG. 2, or a transmission path having an open end and a short-circuited end and a length, lcpw1, around ¼ of the in-tube wavelength such as provided in a third embodiment of the present invention, as shown in FIG. 3. In an alternative, a plurality of the transmission paths may be provided, as in the fourth embodiment shown in FIG. 4. FIG. 13 shows the filter characteristic in the case where the coplanar line 4 has different line lengths lcpw1 and lcpw2. As understood from FIG. 13, by changing the line lengths lcpw1 and lcpw2 independently of one another, the attenuation poles can be controlled independently of each other, whereby the out-of-band component can be suppressed over a wide band range. In this example, the attenuation pole is formed in a lower frequency range of the pass band; however, the attenuation pole may be introduced in the higher frequency range or each of the lower and higher frequency ranges as shown in FIG. 14.

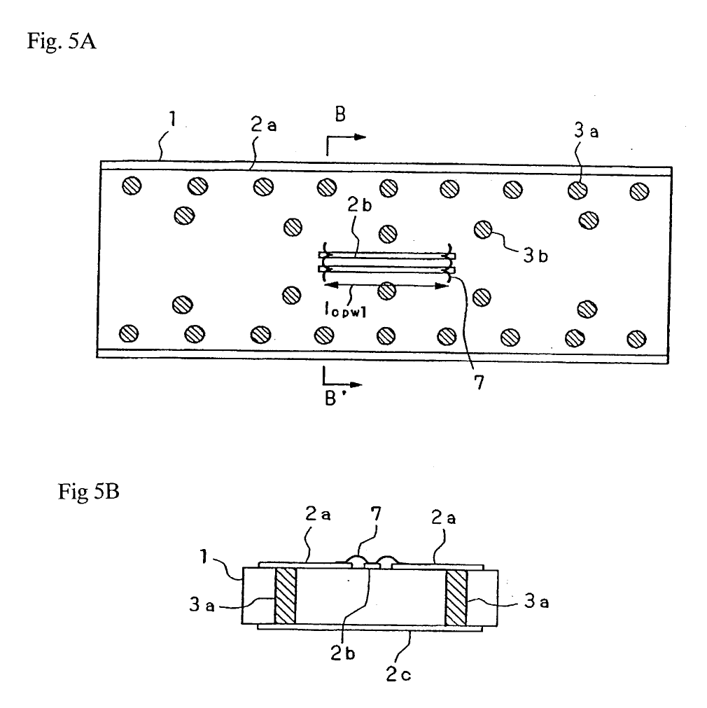

With reference to FIGS. 5A and 5B, a fifth embodiment will be described having a configuration wherein the filter characteristic can be adjusted. By connecting together the conductor layer 2a constituting the ground of the coplanar line 4 and the conductor layer 2b constituting the signal conductor thereof via bonding wires 7, the short-circuit point of the short-circuited-ends coplanar line 4 constituting the subordinate transmission path can be shifted. By this structure, the frequency at which the attenuation pole appears is changed to adjust the filter characteristic. In stead of the bonding wire 7, a gold ribbon etc. may be used. Or else, an air bridge etc., which connects the conductor layer 2a and the conductor layer 2b together is formed in advance during forming the conductor layer on the top surface of the dielectric substrate 1, and is removed for allowing adjustment of the filter characteristic.

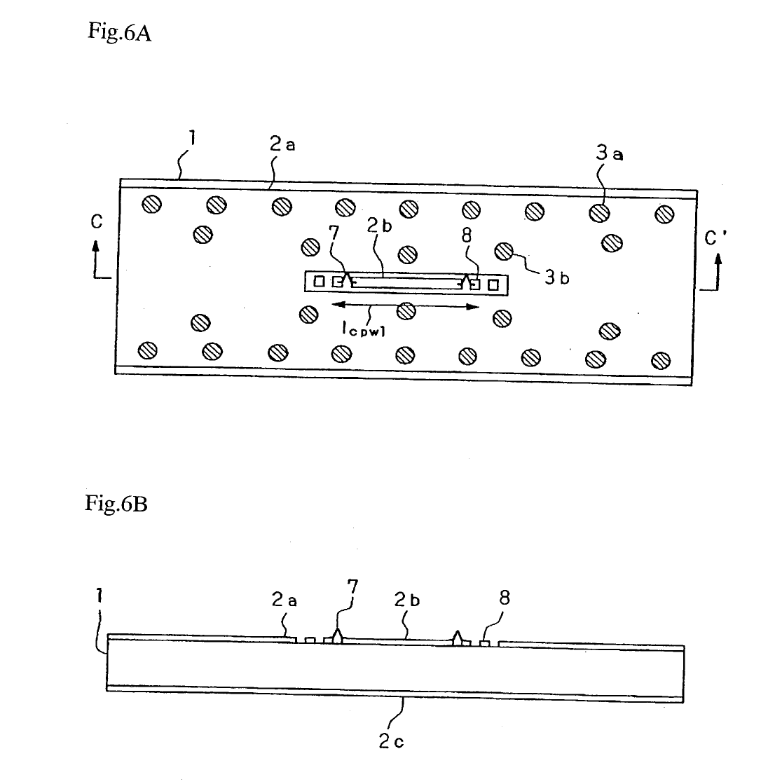

With reference to FIGS. 6A and 6B, a sixth embodiment will be described having another configuration wherein the filter characteristic can be adjusted. A plurality of conductor pieces 8 are formed in advance at locations apart from the conductor layer 2b constituting the signal conductor. By connecting together the conductive pieces 8 and the conductor layer 2b by using bonding wires 7, the open point of the coplanar line 4 having open ends and constituting the subordinate transmission path can be shifted, whereby the filter characteristic can be adjusted as in the case of the short-circuited ends.

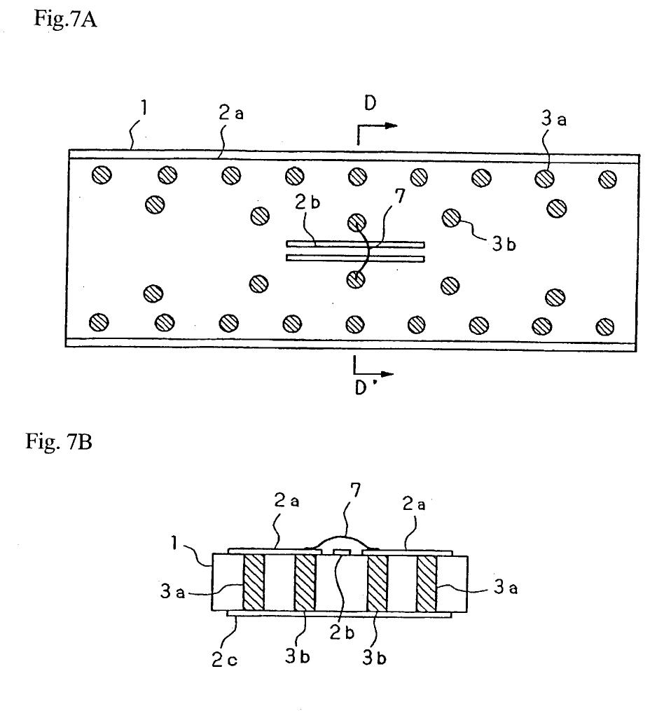

In the above embodiments, the filter characteristic may be sometimes degraded due to transmission of the parasitic slot line mode through the coplanar line 4 constituting the subordinate transmission path. With reference to FIGS. 7A and 7B, the configuration for suppressing the parasitic slot line mode as a seventh embodiment will be described. The conductor layers 2a disposed at both sides of the conductor layer 2b constituting the signal conductor of the coplanar line 4 are connected together via a bonding wire 7. This allows suppression of the slot line mode due to nullifying the potential difference between the conductor layers 2a disposed at both sides of the conductor layer 2b.

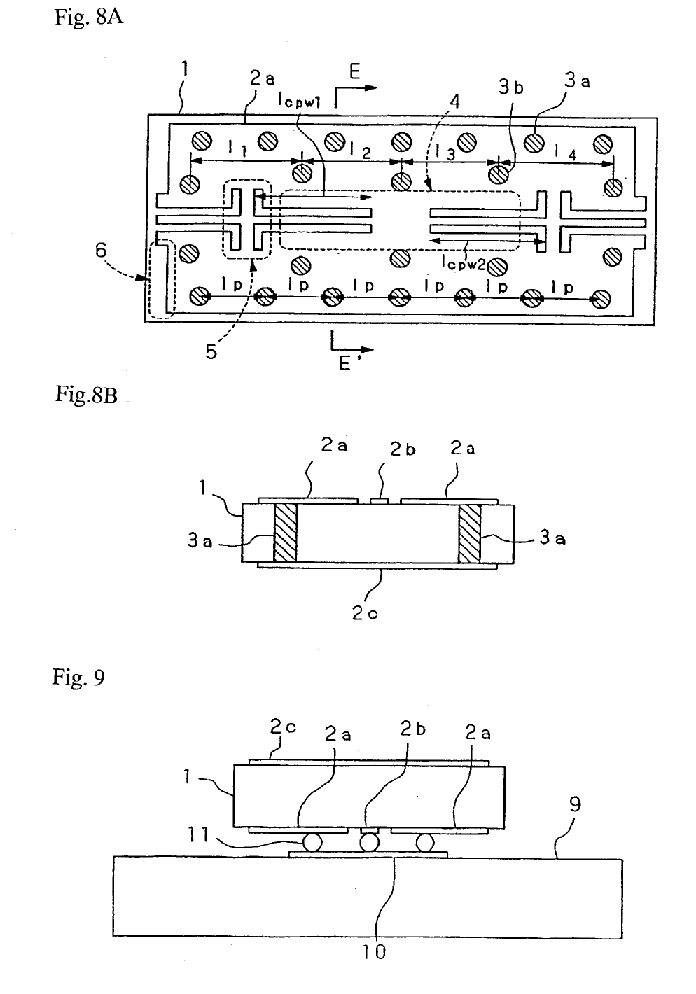

With reference to FIGS. 8A and 8B, an eighth embodiment of the present invention will be described in detail. Conductor layers 2a and 2c are formed on the top and bottom surfaces, respectively, of a dielectric substrate 1 such as made of ceramics, wherein the top conductor layer 2a and the bottom conductor layer 2c are connected together through via-holes 3a penetrating the dielectric substrate 1. The plurality of via-holes 3a are arranged in at least two rows along the signal transfer direction. In order for the area surrounded by the top conductor layer 2a, bottom conductor layer 2c and via-holes 3a to configure a waveguide tube in a desired band, it is preferable that the spacing between the via-holes 3a in the direction parallel to the signal transfer direction be equal to or less than ½ of the in-tube wavelength in the desired band. In addition, in order to sufficiently suppress the loss due to radiation from between the via-holes 3a, it is preferable that the spacing be equal to or less than ¼ of the in-tube wavelength. By forming via-holes 3b arranged in the signal transfer direction at spacings (l1, l2, l3 and l4) equal to or below ½ of the in-tube wavelength, the zone between the via-holes 3b constitutes a resonator. By connecting adjacent resonators together via via-holes 3b constituting inductive windows, a dielectric band-pass filter can be configured. By configuring the coplanar line as a signal input/output line, and using a coplanar waveguide tube conversion section 5 formed on the dielectric substrate 1, the coupling factor of the filter with respect to the outside thereof can be adjusted. The configuration wherein the coplanar line is used as the input/output line allows integration of the filter with the planar circuit of a MMIC (monolithic microwave integrated circuit) etc., whereby flip-chip mounting generally used in a high frequency range can be employed.

Since the most part of the electromagnetic wave is transmitted within the waveguide tube, it is expected that the characteristics are scarcely changed even in the case of the flip-chip mounting. By applying an offset 6 with respect to a part of the conductor layer 2a constituting the input/output section except for the coupling portion to the outside, radiation from the end of the substrate can be reduced. By forming the coplanar line 4 including the conductor layer 2a as the ground and the conductor layer 2b as the signal conductor on the surface of the dielectric substrate 1 so as to overstride two resonators, a subordinate transmission path having short-circuited ends is formed, with the waveguide tube being the main transmission path. The subordinate transmission path provides effects similar to those of the first embodiment. The configuration of the transmission path may be such as having open ends, or having an open end and a short-circuited end, as recited in connection with the second and third embodiments, or may be changed in the number of transmission paths.

Also in such a case, the characteristic of the filter can be adjusted similarly to the case of configuration of the fifth embodiment (FIGS. 5A and 5B); however, flip-chip mounting can be used with ease due to the coplanar line being an input/output section. FIG. 9 shows a ninth embodiment, wherein a filter having a configuration for adjusting the filter characteristic by using a flip-chip mounting technique is shown in a sectional view together with the mounting board. Upon flip-chip bonding the filter substrate, the conductor layer 2a and the conductor layer 2b are connected together via the bumps 11 and a conductor piece 10 which is formed on the flip-chip mounting board 9, whereby the short-circuit point of the transmission path having sort-circuited ends can be adjusted. This allows adjustment of the filter characteristic similarly to the case of the bonding wire 7.

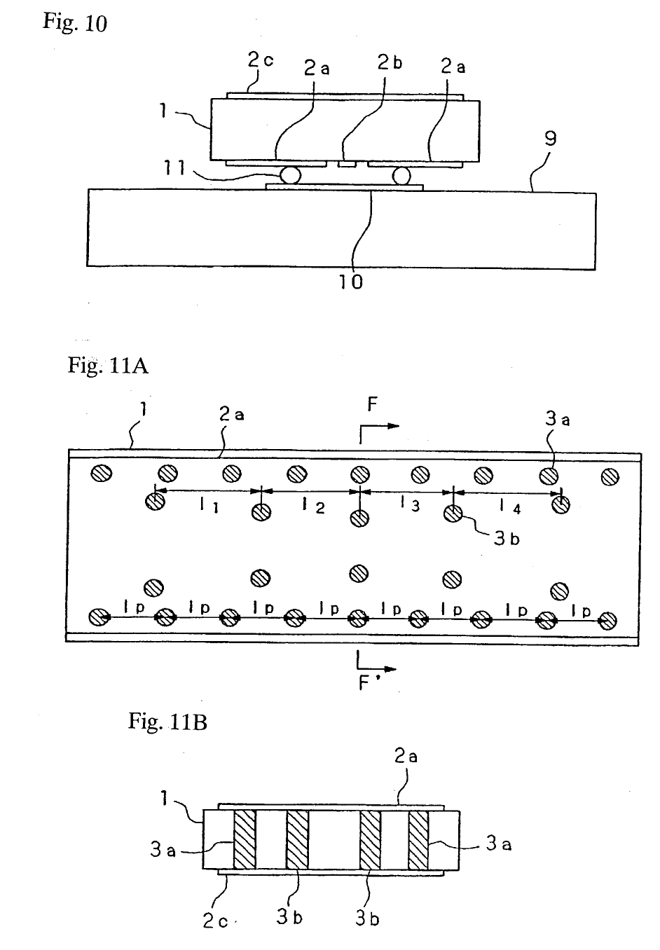

The slot line mode can be suppressed similarly to the method of the seventh embodiment, and also by using a flip-chip mounting technique. FIG. 10 shows a tenth embodiment, wherein a filter having a configuration for suppressing the slot line mode by using the flip-chip mounting technique is shown in sectional view together with the mounting board. Upon mounting the filter substrate by the flip-chip mounting technique, the conductor layers 2a disposed at both sides of the conductor layer 2b are connected together via bumps 11 and a conductive piece 10 which is formed on the mounting board 9, whereby effects similar to those of the bonding wire 7 can be obtained.

In the above description, the length of the resonator along the direction parallel to the signal transfer direction is equal to or below ½ of the in-tube wavelength; however, the length may be an integral multiple of ½ of the in-tube wavelength. In addition, the subordinate transmission path is exemplified by a coplanar line; however, a slot line may be used therein, for example. The filter having four stages is exemplified; however, the number of stages may be increased or decreased therefrom to obtain desired characteristics.

In the dielectric waveguide tube band-pass filter, due to the planar line provided on the conductor plane disposed on the dielectric substrate, a subordinate transmission path is formed, with the waveguide tube being the main transmission path, and an attenuation pole is formed outside the band of the filter, whereby the out-of-band suppression characteristic can be improved. This allows reduction of the number of stages in the filter, thereby achieving smaller dimensions.

The planar line can be formed on the dielectric waveguide tube with more ease compared to the case of forming the same on the metallic waveguide tube. Accordingly, the out-of-band suppression characteristic of the filter can be improved by the simple configuration. The reduction of the number of stages in the filter allows improvement of the product yield.

In a filter having a pseudo waveguide tube structure configured by the top conductor layer and the bottom conductor layer formed on the surfaces of the dielectric substrate, the structure wherein a planar line is provided on the conductor surface on the dielectric substrate, if employed, can form an attenuation pole outside the band of the filter to improve the out-of-band suppression characteristic of the filter.

A configuration wherein the planar line provided on the dielectric substrate configures a secondary transmission path connecting the resonators together, if employed, can form an attenuation pole outside the pass band of the filter to improve the out-of-band suppression characteristic.

A configuration wherein coplanar line including two combined slots is used as the coplanar line formed on the dielectric substrate, if employed, concentrates the electric field on the slot to thereby improve the filter characteristic.

A configuration wherein the ground conductors disposed on both sides of the signal conductor constituting the co-planar line are connected together, if employed, suppresses the slot line mode which may be generated as a higher-order mode of the coplanar line, whereby degradation of the filter characteristic due to the slot line mode can be prevented.

A configuration wherein the conductors provided on both sides of the slot constituting the coplanar line are connected together via a conductor piece for adjusting the filter, if employed, can adjust the position of the short-circuit end of the line having the short-circuited ends to thereby adjust the filter characteristic.

A configuration wherein at least one end of the co-planar line is an open end, a first conductor piece is formed apart from the open end of a signal conductor, and the first conductor piece and said signal conductor are connected together via a second conductor piece for adjusting the filter, if employed, can adjust the position of the open end having the open end, thereby allowing adjustment of the filter characteristic.

A conversion structure wherein the coplanar line is converted to a waveguide tube, if employed, provides a filter capable of being flip-chip mounted.

A configuration wherein conductors constituting the coplanar line are connected together via bumps and a conductor piece which is formed on the flip-chip mounting board, if employed, provides a filter which allows both suppression of the slot line mode and adjustment of the characteristic thereof.

1. A filter comprising a dielectric waveguide tube structure including a top conductor layer and a bottom conductor layer on the surfaces of a dielectric substrate,
wherein the side wall of a waveguide tube and inductive windows are configured by conductors connecting said top conductor layer and said bottom conductor layer together, characterized in that:
a planar line is configured on the surface of at least one of said top conductor layer and said bottom conductor layer.

2. The filter according to claim 1, wherein:
at least two via-hole arrays are formed each including via-holes arranged in a signal transfer direction at spacing equal to or below ½ of an in-tube wavelength in a desired band, each of said via-holes connecting together said top conductor layer and said bottom conductor layer disposed on the surfaces of said dielectric substrate; and
said inductive windows, which couple together resonators in said waveguide tube configured by an area surrounded by said via-hole arrays, said top conductor layer and said bottom conductor layer, ormed by said via-holes.

3. The filter according to claim 1 or 2, wherein:
said planar line on said insulator substrate is formed on said top conductor layer or said bottom conductor layer so as to overstride at least one of said inductive windows; and
said planar line configures a transmission path.

4. The filter according to any one of claims 1 to 3, wherein said planar line formed on said dielectric substrate is a co-planar line configured by combined two slots formed along the transfer direction of a signal transferring in the waveguide tube.

5. The filter according to claim 4, wherein ground conductors on both sides of a signal conductor configuring said coplanar line are connected together via a conductor piece.

6. The filter according to any one of claims 1 to 5, wherein conductors on both sides of a slot configuring said planar line are connected together via a conductor piece for adjusting said filer.

7. The filter according to claim 4 or 5, wherein:
at least one of both ends of said co-planar line is an open end, and a first conductor piece is formed apart from said open end of a signal conductor; and
said first conductor piece and said signal conductor are connected together via a second conductor piece for adjusting said filter.

8. The filter according to any one of claims 1 to 7, wherein said filter includes a coplanar line for inputting/outputting a signal, and a conversion structure for a coplanar waveguide tube.

9. The filter according to any one of claims 5 to 8, wherein said conductors configuring said planar line are connected together via a conductor piece formed on a flip-chip mounting board and bumps.
